(19) United States
(12) Patent Application Publication
(10) Pub. No.: US 2026/0348880 A1
(43) Pub. Date: Nov. 5, 2026

(54) IMAGING SYSTEMS WITH MOVING RADIATION SOURCE AND CORRESPONDING OPERATION METHODS

(71) Applicant: SHENZHEN XPECTVISION TECHNOLOGY CO., LTD., Guangdong (CN)

(72) Inventor: Yurun LIU, Guangdong (CN)

(73) Assignee: SHENZHEN XPECTVISION TECHNOLOGY CO., LTD., Guangdong (CN)

(21) Appl. No.: 19/199,349

(22) Filed: May 5, 2025

Related U.S. Application Data
(63) Continuation of application No. PCT/CN2023/120319, filed on Sep. 21, 2023.

(51) Int. Cl. G01N 23/04

(52) U.S. Cl. CPC G01N 23/04; G01N 2223/204

(57) ABSTRACT

A system has: an electron source configured to send an electron beam, a target with target spots (i) (i=1, . . . , M, M being an integer greater than 1), and an X-ray detector with sensing elements (i) (i=1, . . . , M). The X-ray detector is configured to capture an image of an object. The object has an object point. For each value of i and one value of i at a time, (A) the electron source is configured to direct the electron beam at the target spot (i), thereby generating X-rays (i) from the target spot (i), and (B) the sensing element (i) is configured to capture a signal (i) of the object point based on an interaction between the X-rays (i) and the object point. The system generates a combined signal of the object point based on at least the signals (i), i=1, . . . , M of the object point.

### CROSS-REFERENCE TO RELATED APPLICATION

This application is a continuation of International Patent Application of PCT application serial No. PCT/CN2023/120319, filed on Sep. 21, 2023. The content of the aforementioned applications, including any intervening amendments thereto, are incorporated herein by reference.

### TECHNICAL FIELD

The present application belongs to an imaging systems technology, and in particular relates to an imaging systems with moving radiation source and corresponding operation methods.

### BACKGROUND

An X-ray imaging system can include an X-ray source and an X-ray detector. An object to be imaged by the imaging system can be positioned between the X-ray source and the X-ray detector. The X-ray source can send out X-rays; and the X-ray detector can capture an image of the object based on the interaction between the X-rays and the object.

### SUMMARY

Disclosed herein is an imaging system that has: an electron source configured to send an electron beam, a target with M target spots (target spots (i), i=1, . . . , M, M being an integer greater than 1), and an X-ray detector with M sensing elements (sensing elements (i), i=1, . . . , M). The X-ray detector is configured to capture an image of an object. The object has an object point. For each value of i and one value of i at a time, (A) the electron source is configured to direct the electron beam at the target spot (i), thereby generating X-rays (i) from the target spot (i), and (B) the sensing element (i) is configured to capture a signal (i) of the object point based on an interaction between the X-rays (i) and the object point. The imaging system is configured to generate a combined signal of the object point based on at least the signals (i), i=1, . . . , M of the object point.

In an aspect, the M target spots are arranged in a two-dimensional array.

In an aspect, the M target spots are arranged in a one-dimensional array.

In an aspect, a value of the combined signal of the object point is a sum of values (i), i=1, . . . , M respectively of the signals (i), i=1, . . . , M of the object point.

In an aspect, for each value of i, the value (i) of the signal (i) of the object point is a number of X-ray photons of the X-rays (i) incident on the sensing element (i).

In an aspect, the target and the X-ray detector are stationary relative to each other.

In an aspect, each of the M target spots has a maximum dimension of at most 10μm.

In an aspect, no plane intersects all sensing elements of the X-ray detector.

In an aspect, a ratio of (A) a distance between a point on the X-ray detector and a point on the object to (B) a distance between the point on the object and a point on the target is at least 5.

An operation method of using the imaging system above includes: for each value of i and one value of i at a time, (A) directing the electron beam at the target spot (i), thereby generating the X-rays (i) from the target spot (i) and (B) capturing with the sensing element (i) the signal (i) of the object point based on an interaction between the X-rays (i) and the object point; and generating the combined signal of the object point based on at least the signals (i), i=1, . . . , M of the object point.

In an aspect, the M target spots are arranged in a two-dimensional array, and the object, the target, and the X-ray detector are stationary relative to each other.

In an aspect, the object is a rolled battery film.

In an aspect, the operation method further includes moving the object relative to the X-ray detector. The M target spots are arranged in a one-dimensional array, and the target and the X-ray detector are stationary relative to each other.

In an aspect, the object is a flat battery film.

In an aspect, said moving the object is in a direction parallel to a straight line that intersects all the M target spots.

In an aspect, said moving the object is such that a resulting path of the object relative to the X-ray detector is not a straight line.

### BRIEF DESCRIPTION OF THE DRAWINGS

FIG. 1 schematically shows a perspective view of an imaging system in an operation, according to an embodiment.

FIG. 2 shows a flowchart generalizing the operation of the imaging system, according to an embodiment.

FIG. 3A to FIG. 3D schematically show a perspective view of the imaging system of FIG. 1 in another operation, according to an alternative embodiment.

### DETAILED DESCRIPTION OF DISCLOSURED EMBODIMENTS

### Imaging System

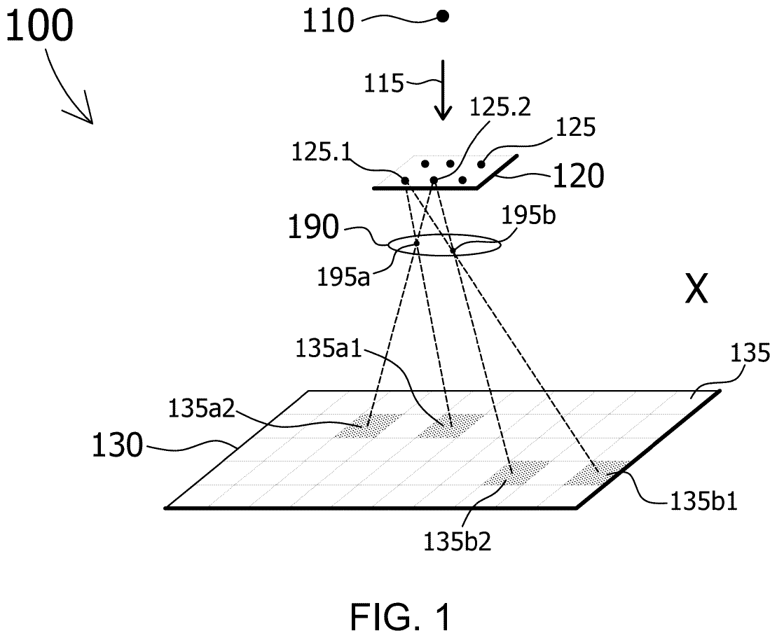

FIG. 1 schematically shows a perspective view of an imaging system 100, according to an embodiment. In an embodiment, the imaging system 100 may include an electron source 110, a target 120, and an X-ray detector 130.

### Electron Source

In an embodiment, with reference to FIG. 1, the electron source 110 may send an electron beam 115. In an embodiment, the electron beam 115 may be a pencil beam. The electron source 110 can be any suitable type, e.g., a thermionic emission source and a field emission source. The electron source 110 may include suitable electron optics to shape and direct the electron beam 115.

### Target

In an embodiment, with reference to FIG. 1, the target 120 may be a thin film or a plate which may include a heavy element such as platinum, copper, iron, chrome, tungsten, or any combination thereof.

### X-Ray Detector

In an embodiment, with reference to FIG. 1, the X-ray detector 130 may include multiple sensing elements 135 (e.g., 50 sensing elements 135 as shown). In an embodiment, the sensing elements 135 of the X-ray detector 130 may be arranged in a two-dimensional array (e.g., 5 rows and 10 columns as shown).

In an embodiment, all the sensing elements 135 of the X-ray detector 130 may be on the same plane. In other words, there is a plane that intersects all the 50 sensing elements 135 of the X-ray detector 130. In an alternative embodiment, all the sensing elements 135 of the X-ray detector 130 may be not on the same plane. In other words, no plane intersects all the 50 sensing elements 135 of the X-ray detector 130.

### Object

In an embodiment, with reference to FIG. 1, an object 190 to be imaged may be positioned between the target 120 and the X-ray detector 130 (as shown).

In an embodiment, the ratio of (A) the distance between a point on the X-ray detector 130 and a point on the object 190 to (B) the distance between the point on the object 190 and a point on the target 120 may be at least 5.

### Operation of Imaging System

In an embodiment, with reference to FIG. 1, the imaging system 100 may operate as follows.

In an embodiment, the target 120, the object 190, and the X-ray detector 130 may be stationary relative to each other during the operation of the imaging system 100. In an embodiment, the object 190 may be a rolled battery film.

In an embodiment, during a first exposure, the electron source 110 may direct the electron beam 115 at a target spot 125.1 on the target 120, thereby generating first X-rays (not shown) from the target spot 125.1. In an embodiment, a sensing element 135a1 of the X-ray detector 130 may capture a first signal of an object point 195a of the object 190 based on the interaction between the first X-rays and the object point 195a. For example, the first signal may represent the intensity of the first X-rays after passing through the object 190.

The interaction between the first X-rays and the object point 195a may include scenarios such as: (A) some of the radiation particles of the first X-rays that are incident on the object point 195a are blocked by the object point 195a, and (B) some of the radiation particles of the first X-rays that are incident on the object point 195a travel through the object point 195a without changing their directions.

The term “object point” may also mean “object portion”. Note that a straight line intersects the target spot 125.1, the object point 195a, and the sensing element 135a1. The words “first”, “second”, and other ordinal numerals in the present patent application (including the claims) are used only for easy reference and do not imply any chronological order.

In an embodiment, during a second exposure which occurs after the first exposure ends, the electron source 110 may direct the electron beam 115 at a target spot 125.2 on the target 120, thereby generating second X-rays (not shown) from the target spot 125.2. In an embodiment, a sensing element 135a2 of the X-ray detector 130 may capture a second signal of the object point 195a of the object 190 based on the interaction between the second X-rays and the object point 195a. Note that a straight line intersects the target spot 125.2, the object point 195a, and the sensing element 135a2.

In an embodiment, the X-ray detector 130 may generate a combined signal of the object point 195a based on the first and second signals of the object point 195a.

Note that the electron beam 115 hits the target spots 125.1 and 125.2 one after another (i.e., not simultaneously). As a result, in the imaging system 100, at any time point, X-rays (if any) are generated from only one target spot 125.

In an embodiment, all the sensing elements 135 that capture the signals of the object point 195a may not be the same. For example, as described above, the sensing elements 135a1 and 135a2 that respectively capture the first and second signals of the object point 195a are not the same (i.e., they are 2 different sensing elements 135 of the X-ray detector 130).

### Measurements of Signals

In an embodiment, the first signal of the object point 195a may be measured by the number N1 of X-ray photons of the first X-rays that are incident on the sensing element 135a1. Note that N1 can be considered a value of the first signal of the object point 195a.

Similarly, in an embodiment, the second signal of the object point 195a may be measured by the number N2 of X-ray photons of the second X-rays that are incident on the sensing element 135a2. Note that N2 can be considered a value of the second signal of the object point 195a.

In an embodiment, the combined signal of the object point 195a may be measured by the sum of N1 and N2 (i.e., N1+N2). Note that the sum of N1 and N2 can be considered a value of the combined signal of the object point 195a.

### Flowchart Generalizing Operation of Imaging System

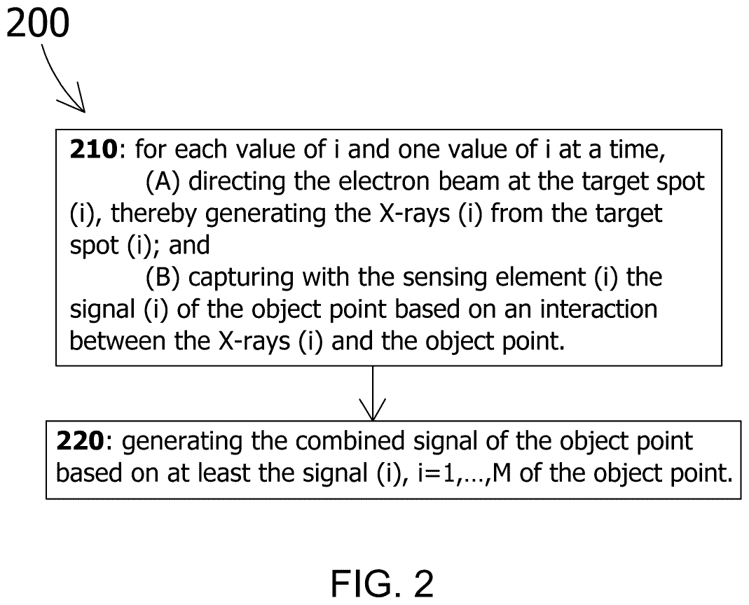

FIG. 2 shows a flowchart 200 generalizing the operation of the imaging system 100 of FIG. 1, according to an embodiment.

In step 210, the operation may include for each value of i and one value of i at a time, (A) directing the electron beam at the target spot (i), thereby generating the X-rays (i) from the target spot (i); and (B) capturing with the sensing element (i) the signal (i) of the object point based on an interaction between the X-rays (i) and the object point. For example, in the embodiments described above, with reference to FIG. 1, during the first exposure, the electron beam 115 is directed at the target spot 125.1, thereby generating the first X-rays from the target spot 125.1; and (B) the sensing element 135a1 captures the first signal of the object point 195a based on the interaction between the first X-rays and the object point 195a. Then, during the second exposure, the electron beam 115 is directed at the target spot 125.2, thereby generating the second X-rays from the target spot 125.2; and (B) the sensing element 135a2 captures the second signal of the object point 195a based on the interaction between the second X-rays and the object point 195a.

In step 220, the operation may include generating the combined signal of the object point based on at least the signals (i), i=1, . . . , M of the object point. For example, in the embodiments described above, with reference to FIG. 1, the X-ray detector 130 generates the combined signal of the object point 195a based on the first and second signals of the object point 195a.

### Other Embodiments

### Other Object Points of Object

In an embodiment, with reference to FIG. 1, the combined signals of the remaining object points of the object 190 may be generated in a manner similar to the manner in which the combined signal of the object point 195a is generated.

For example, the combined signal of an object point 195b of the object 190 may be generated as follows. During the first exposure, a sensing element 135b1 of the X-ray detector 130 may capture a first signal of the object point 195b based on the interaction between the first X-rays and the object point 195b. Then, during the second exposure, a sensing element 135b2 of the X-ray detector 130 may capture a second signal of the object point 195b based on the interaction between the second X-rays and the object point 195b. Then, the X-ray detector 130 may generate the combined signal of the object point 195b based on the first and second signals of the object point 195b.

In an embodiment, the X-ray detector 130 may generate an image of the object 190 based on the combined signals of all object points 195 of the object 190 (including the object points 195a and 195b).

### More Than 2 Target Spots Involved

In the embodiments described above, with reference to FIG. 1, two target spots 125 are involved in generating the combined signal of an object point 195. For example, the 2 target spots 125.1 and 125.2 are involved in generating the combined signal of the object point 195a. Similarly, the 2 target spots 125.1 and 125.2 are involved in generating the combined signal of the object point 195b.

In an embodiment, more than 2 target spots 125 may be involved in generating the combined signal of an object point 195. For example, 6 target spots 125 shown in FIG. 1 (including the target spots 125.1 and 125.2) may be involved (one after another) in generating the combined signal of the object point 195a.

In an embodiment, the target spots 125 involved in generating the combined signal of an object point 195 may be arranged in a two-dimensional array (e.g., 2 rows and 3 columns as shown in FIG. 1).

In an embodiment, each of the target spots 125 involved in generating the combined signal of an object point 195 may have a maximum dimension of at most 10 μm.

### A Target Spot May Be Involved More Than Once

In the embodiments described above, with reference to FIG. 1, each of the target spots 125 involved in generating the combined signal of an object point 195 is involved once. For example, each of the 2 target spots 125.1 and 125.2 involved in generating the combined signal of the object point 195a is involved only once.

In an embodiment, at least a target spot 125 involved in generating the combined signal of an object point 195 is involved more than once. For example, 7 exposures (instead of 2 as described above) may occur one after another for generating the combined signal of the object point 195a. The first 6 exposures may involve respectively the 6 target spots 125 shown in FIG. 1, and then the 7^{th} exposure may involve the target spot 125.1 a second time. As a result, the target spot 125.1 is involved twice (i.e., more than once) in generating the combined signal of the object point 195a.

### Alternative Embodiments

### Position of Electron Source

In the embodiments described above, with reference to FIG. 1, the electron source 110 and the X-ray detector 130 are on 2 opposite sides of the target 120. This arrangement is not required for the imaging system 100 to operate. In an alternative embodiment, the electron source 110 and the X-ray detector 130 may be on the same side of the target 120. For example, the electron source 110 may be at position X as marked in FIG. 1.

### Object Moves Relative to X-Ray Detector

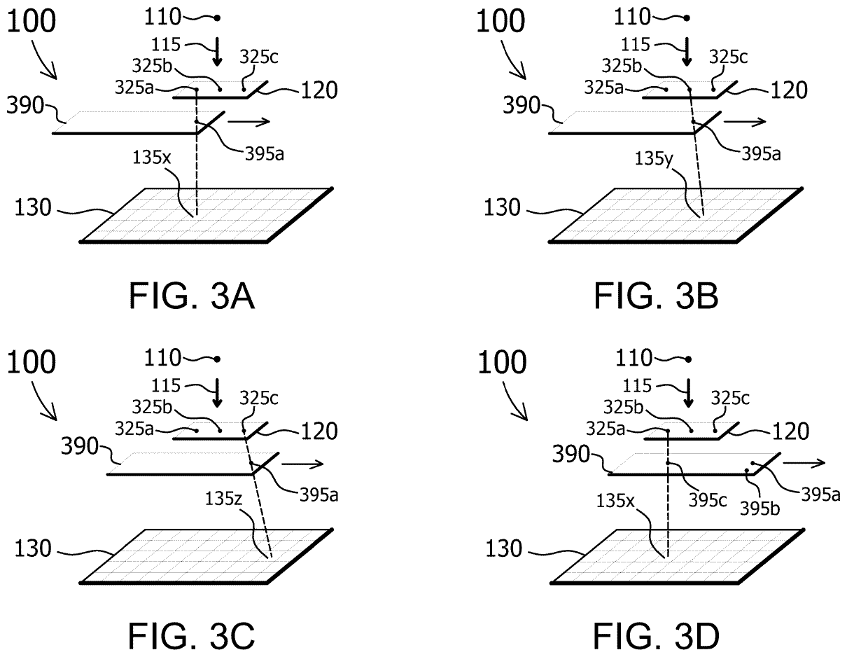

In the embodiments described above, with reference to FIG. 1, the object 190 is stationary relative to the X-ray detector 130 during the operation of the imaging system 100. In an alternative embodiment, with reference to FIG. 3A to FIG. 3D, an object 390 to be imaged may move relative to the X-ray detector 130 during the operation of the imaging system 100, while the X-ray detector 130 and the target 120 remain stationary relative to each other.

In an embodiment, with reference to FIG. 3A to FIG. 3D, the object 390 may be positioned between the target 120 and the X-ray detector 130 (as shown). In an embodiment, the object 390 may be a flat battery film.

In an embodiment, with reference to FIG. 3A to FIG. 3D, the imaging system 100 may operate as follows.

In an embodiment, with reference to FIG. 3A, during a fourth exposure, the electron source 110 may direct the electron beam 115 at a target spot 325a of the target 120, thereby generating fourth X-rays (not shown) from the target spot 325a. In an embodiment, a sensing element 135x of the X-ray detector 130 may capture a fourth signal of an object point 395a of the object 390 based on the interaction between the fourth X-rays and the object point 395a. Note that a straight line intersects the target spot 325a, the object point 395a, and the sensing elements 135x.

In an embodiment, with reference to FIG. 3B, during a fifth exposure which occurs after the fourth exposure ends, the electron source 110 may direct the electron beam 115 at a target spot 325b of the target 120, thereby generating fifth X-rays (not shown) from the target spot 325b. In an embodiment, a sensing element 135y of the X-ray detector 130 may capture a fifth signal of the object point 395a based on the interaction between the fifth X-rays and the object point 395a. Note that a straight line intersects the target spot 325b, the object point 395a, and the sensing elements 135y.

In an embodiment, with reference to FIG. 3C, during a sixth exposure which occurs after the fifth exposure ends, the electron source 110 may direct the electron beam 115 at a target spot 325c of the target 120, thereby generating sixth X-rays (not shown) from the target spot 325c. In an embodiment, a sensing element 135z of the X-ray detector 130 may capture a sixth signal of the object point 395a based on the interaction between the sixth X-rays and the object point 395a. Note that a straight line intersects the target spot 325c, the object point 395a, and the sensing elements 135z.

In an embodiment, the X-ray detector 130 may generate a combined signal of the object point 395a based on the fourth, fifth, and sixth signals of the object point 395a.

In an embodiment, with reference to FIG. 3A to FIG. 3D, the 3 target spots 325a, 325b, and 325c involved in generating the combined signal of the object point 395a may be arranged in a one-dimensional array (as shown).

In an embodiment, the movement of the object 390 relative to the X-ray detector 130 may be in a direction parallel to a straight line that intersects all the target spots 325a, 325b, and 325c. Alternatively, the path of the object 390 may not be a straight line.

In an embodiment, the combined signals of the remaining object points of the object 390 may be generated in a manner similar to the manner in which the combined signal of the object point 395a is generated.

For example, the combined signal of an object point 395b (FIG. 3D) of the object 390 may be generated based on the fourth, fifth, and sixth signals of the object point 395b which are captured during the fourth, fifth, and sixth exposures respectively.

For another example, the combined signal of an object point 395c (FIG. 3D) of the object 390 may be generated based on seventh, eight, and ninth signals of the object point 395c which are captured during seventh, eight, and ninth exposures respectively. The seventh, eight, and ninth exposures (A) occur one after another in that order after the sixth exposure ends and (B) are similar to the fourth, fifth, and sixth exposures respectively.

In an embodiment, the X-ray detector 130 may generate an image of the object 390 based on the combined signals of all object points of the object 390 (including the object points 395a and 395b).

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. An imaging system, comprising:
an electron source configured to send an electron beam;
a target comprising M target spots (target spots (i), i=1, . . . , M), with M being an integer greater than 1; and
an X-ray detector comprising M sensing elements (sensing elements (i), i=1, . . . , M), and configured to capture an image of an object, the object comprising an object point,
wherein for each value of i and one value of i at a time,
(A) the electron source is configured to direct the electron beam at the target spot (i), thereby generating X-rays (i) from the target spot (i), and
(B) the sensing element (i) is configured to capture a signal (i) of the object point based on an interaction between the X-rays (i) and the object point, and
wherein the imaging system is configured to generate a combined signal of the object point based on at least the signals (i), i=1, . . . , M of the object point.

2. The imaging system of claim 1, wherein the M target spots are arranged in a two-dimensional array.

3. The imaging system of claim 1, wherein the M target spots are arranged in a one-dimensional array.

4. The imaging system of claim 1, wherein a value of the combined signal of the object point is a sum of values (i), i=1, . . . , M respectively of the signals (i), i=1, . . . , M of the object point.

5. The imaging system of claim 4, wherein for each value of i, the value (i) of the signal (i) of the object point is a number of X-ray photons of the X-rays (i) incident on the sensing element (i).

6. The imaging system of claim 1, wherein the target and the X-ray detector are stationary relative to each other.

7. The imaging system of claim 1, wherein each of the M target spots has a maximum dimension of at most 10 μm.

8. The imaging system of claim 1, wherein no plane intersects all sensing elements of the X-ray detector.

9. The imaging system of claim 1, wherein a ratio of (A) a distance between a point on the X-ray detector and a point on the object to (B) a distance between the point on the object and a point on the target is at least 5.

10. An operation method of using the imaging system of claim 1, the operation method comprising:
for each value of i and one value of i at a time, (A) directing the electron beam at the target spot (i), thereby generating the X-rays (i) from the target spot (i) and (B) capturing with the sensing element (i) the signal (i) of the object point based on an interaction between the X-rays (i) and the object point; and
generating the combined signal of the object point based on at least the signals (i), i=1, . . . , M of the object point.

11. The operation method of claim 10,
wherein the M target spots are arranged in a two-dimensional array, and
wherein the object, the target, and the X-ray detector are stationary relative to each other.

12. The operation method of claim 11, wherein the object is a rolled battery film.

13. The operation method of claim 10, further comprising moving the object relative to the X-ray detector,
wherein the M target spots are arranged in a one-dimensional array, and
wherein the target and the X-ray detector are stationary relative to each other.

14. The operation method of claim 13, wherein the object is a flat battery film.

15. The operation method of claim 13, wherein said moving the object is in a direction parallel to a straight line that intersects all the M target spots.

16. The operation method of claim 13, wherein said moving the object is such that a resulting path of the object relative to the X-ray detector is not a straight line.
